(19) United States
(12) Patent Application Publication
(10) Pub. No.: US 2024/0163632 A1
(43) Pub. Date: May 16, 2024

(54) ACOUSTIC PATH TESTING

(71) Applicant: Bose Corporation, Framingham, MA (US)

(72) Inventors: Andrew Thomas Pyzdek, Acton, MA (US); Yashar Motedayen Aval, Belmont, MA (US)

(21) Appl. No.: 18/389,413

(22) Filed: Nov. 14, 2023

Related U.S. Application Data
(60) Provisional application No. 63/425,045, filed on Nov. 14, 2022.

(51) Int. Cl. H04S 7/00; G10K 11/178; H04R 29/00

(52) U.S. Cl. CPC H04S 7/308; G10K 11/17815; H04R 29/004; H04S 7/301; H04R 2499/13; H04S 2400/15; H04S 2420/01

(57) ABSTRACT

An audio method, system, and computer readable medium is provided that estimates an acoustic transfer function in an environment between a transducer and a microphone. An audio test signal is generated, wherein an amplitude or energy of the audio test signal is selected, across a plurality of frequency bins, at least in part, to be at least partially masked by acoustic energy in the environment. The audio test signal is provided to a transducer to be transduced into an acoustic signal in the environment. The microphone receives the acoustic signal and provides a microphone signal. The microphone signal is processed through a summing method over a predetermined time duration of three (3) seconds or longer, and the acoustic transfer function is estimated based upon the summing method.

### CROSS REFERENCE TO RELATED APPLICATIONS

This application claims priority to U.S. Provisional Patent Application No. 63/425,045, filed on Nov. 14, 2022, which is incorporated by reference in its entirety.

### BACKGROUND

Various audio systems incorporate an estimate of an acoustic transfer function, e.g., through one or more acoustic paths, to improve performance of the system. For example, the transfer of sound from a loudspeaker to a microphone (often an error microphone, or feedback microphone) may be called a secondary path in many applications, such as road noise cancellation (RNC) or engine harmonic cancellation (EHC), to name a couple, in automotive or vehicle situations. The primary path is the path that the road noise or engine harmonic sound takes from the source to the microphone (typically located near an occupant's ears, or as near as possible).

In many cases, an estimate of the acoustic transfer function may be pre-measured and stored in a memory of the system. Such an approach has some drawbacks, such as the predetermined measurement is representative of the transfer function at only one point in time, when the measurement was made, and may be representative of the transfer function in only one configuration of the acoustic space. For example, in an automotive environment, a measured transfer function is representative of a vehicle's interior configuration at the time, e.g., which and how many seats are occupied, size(s) of the occupant(s), seat positions, cargo loading, etc. Accordingly, various acoustic environments may have acoustic characteristics that change greatly over time. Therefore, there exists a need to actively estimate acoustic transfer functions in real time, under the current conditions affecting the acoustic environment.

### SUMMARY

Systems and methods are disclosed herein for estimating an acoustic transfer function by generating an audio test signal (or training signal) of relatively low energy so that it will be relatively indistinguishable (by the human ear) from other sound in the environment.

According to various aspects, an audio method, system, and computer readable medium is provided that estimates an acoustic transfer function in an environment between a transducer and a microphone that includes generating an audio test signal, wherein an amplitude or energy of the audio test signal is selected, across a plurality of frequency bins, at least in part, to be at least partially masked by acoustic energy in the environment, providing the audio test signal to the transducer to be transduced into an acoustic signal in the environment, receiving a microphone signal from the microphone based upon the acoustic signal at the microphone in the environment, performing a summing method on the microphone signal over a predetermined time duration of three (3) seconds or longer, and determining the estimated acoustic transfer function based upon the summing method.

According to some examples, the predetermined duration may be at least one of five (5) seconds or longer, ten (10) seconds or longer, twenty (20) seconds or longer, or sixty (60) seconds or longer.

In various examples, the amplitude or energy of the audio test signal may be selected based at least in part upon an acoustic energy content in the environment. In certain examples, the amplitude or energy of the audio test signal may also or alternatively be selected based at least in part upon an energy content of a playback signal, the playback signal also being transduced into the environment.

In various examples the summing method may include adding a first fractional value of the microphone signal to a second fractional value of a stored signal and saving the result as a new version of the stored signal. In certain examples the first fractional value and the second fractional value add up to unity.

In some examples, the summing method may further include repeatedly adding subsequent first fractional values of the microphone signal to subsequent second fractional values of the stored signal and saving the result as a next subsequent version of the stored signal multiple times over the duration. In various examples the repeated summing method may be performed at least one of ten (10) times or more, twenty (20) times or more, one hundred (100) times or more, or two hundred times (200) or more over the duration.

In various examples the summing method may be performed on each of a plurality of frequency bins of the microphone signal.

Still other aspects, examples, and advantages of these exemplary aspects and examples are discussed in detail below. Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification but are not intended as a definition of the limits of the invention(s). In the figures, identical or nearly identical components illustrated in various figures may be represented by a like reference character or numeral. For purposes of clarity, not every component may be labeled in every figure. In the figures:

FIG. 1 is a schematic system diagram of an example noise cancellation system;

FIG. 2 is a schematic system diagram of an example acoustic path testing system incorporated with the noise cancellation system of FIG. 1; and

FIG. 3 is a method diagram of an example method that may be performed by the example acoustic path testing system of FIG. 2.

### DETAILED DESCRIPTION

Aspects of the present disclosure are directed to systems and methods for estimating an acoustic transfer function by generating an audio test signal (or training signal) of relatively low energy so that it will be relatively indistinguishable (by the human ear) from other sound in the environment (i.e., the test signal will be ‘masked’ by other sounds in the environment), transducing the test signal into an acoustic signal, receiving the acoustic signal at a microphone, and processing the received microphone signal over a duration of time. At least a few benefits of this approach are that (a) the test signal will not generally be heard by most people and so will go unnoticed, (b) the test signal can be essentially continuously ongoing because it is not heard by occupants of the environment, and (c) the systems and methods can benefit from the processing gain achieved by processing the received microphone signal over a duration of time (e.g., rather than at one time of testing).

The innovations described herein may be understood as akin to processing of spread spectrum radio signals, and more particularly to processing pilot signals in orthogonal frequency division multiplexing (OFDM). Unlike OFDM pilot signals, however, the systems and methods herein apply to testing an acoustic channel with acoustic energy at baseband audio frequencies rather than testing a radio channel at radio frequency (RF). In the radio frequency analogy, testing the RF transfer function is known as channel estimation. Understanding the RF channel characteristics (e.g., how the radio signal is affected by its propagation, and reflections, between the transmitter and receiver) is useful in improving the receiver's performance at interpreting the signal and demodulating it into a communication data stream.

As a further analogy to radio systems, which often have multipath characteristics (due to reflections) and often use multiple transmit antennas and multiple receive antennas and are therefore multi-input multi-output (MIMO) systems (thereby having multiple paths from ‘transmit’ to ‘receive’ and an accordingly more complex effect of the channel characteristics on the received signals), many acoustic environments also have multiple sound sources (e.g., loudspeakers), multiple paths to a microphone, and multiple acoustic receivers (e.g., microphones). For example, an automobile audio system typically has multiple perimeter loudspeakers and may have multiple microphones for monitoring the performance of a noise cancellation, harmonic cancellation, or other active sound management subsystem. Accordingly, systems and methods described herein are applicable to MIMO acoustic environments and perform acoustic channel estimation (acoustic transfer function estimation) in such environments.

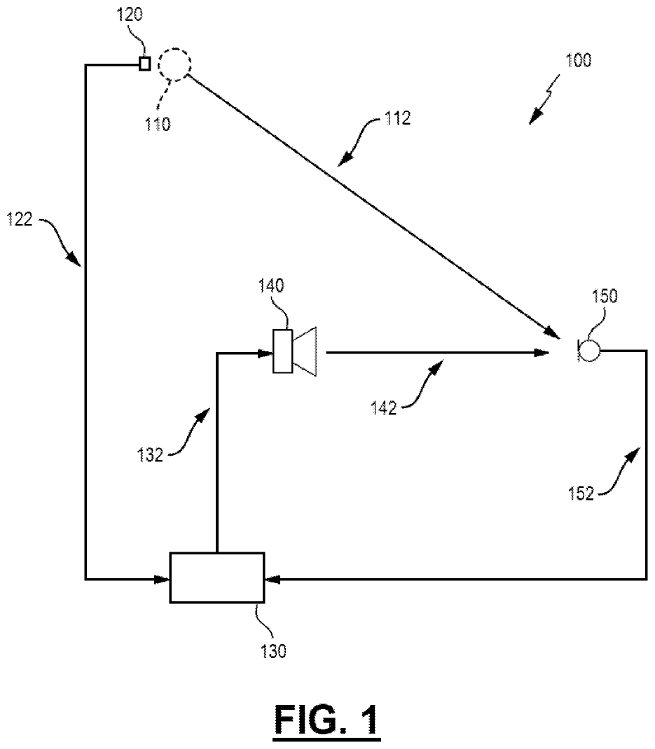

FIG. 1 illustrates an example noise reduction system 100, which is one example of a system in which acoustic path testing systems and methods as described herein may be beneficially applied. The noise reduction system 100 is one of a number of systems in which the system may benefit from determining an acoustic transfer function from one location to another, and the noise reduction system 100 is briefly described for reference. A noise source 110 may generate noise in an environment. For example, the noise source 110 may be an interaction between one or more wheels of a vehicle and a road for an example noise reduction system 100 that may be a road noise cancellation (RNC) system. In another example, the noise source 110 may be an internal combustion engine (ICE) and the noise reduction system 100 may be an engine harmonic cancellation (EHC) system. In any event a sensor 120 may detect and provide a reference signal 122 indicative of the noise generated by the noise source 110. For example, vibration signals from one or more accelerometers may indicate the vibration of a wheel on a road or may indicate harmonic vibrations of an engine. In another example, and RPM sensor may indicate the rotations per minute (RPM) of an engine, from which harmonic frequencies may be calculated.

A controller 130 receives the reference signal 122 and produces a command signal 132 based at least in part upon the reference signal 122. The command signal 132 is transduced into an acoustic signal by an acoustic transducer 140 (such as a loudspeaker, e.g., in the cabin of an automobile, for instance).

According to various systems, a feedback microphone 150 may be located in the environment in which the noise reduction system 100 operates to reduce noise, such as in a vehicle cabin, or one or more seating locations in such a vehicle cabin. The controller 130 may beneficially receive a feedback signal 152 from the feedback microphone 150 to improve the operation of the controller 130, e.g., to determine improved command signals 132 based upon the reference signal 122. Accordingly, in many noise reduction systems, a controller 130 may produce a command signal 132 based upon one or more reference signals 122 and one or more feedback signals 152.

Regarding terminology, an area of the environment in which noise is to be reduced may be referred to as a cancellation zone or region. The noise is transferred from the noise source 110 to the cancellation zone (and the feedback microphone 150) via a primary path 112. The mechanical and acoustic propagation—such as road noise transmitted from the suspension system into the vehicle cabin—defines the primary path 112. A relationship between the feedback signal 152, which represents the noise in the cancellation zone, and the reference signal 122, which represents the noise at the noise source 110, in the absence of any other sounds in the environment, is representative of the transfer function of the primary path 112. Note that the controller 130 receives each of the reference signal 122 and the feedback signal 152, and therefore is capable of determining the transfer function of the primary path 112, at least in the absence of any other sound (or if the controller 130 takes into account the presence of other sound).

The acoustic transfer from the acoustic transducer 140 to the feedback microphone 150 is a secondary path 142. Many known noise reduction systems benefit from determining an estimate of the acoustic transfer function from the acoustic transducer 140 to the feedback microphone 150. The systems and methods described herein are directed to determining an estimate of the transfer function of the secondary path 142.

Systems and methods herein generate a test (or training) audio signal by selecting amounts of signal energy to be transmitted (e.g., by a loudspeaker) in individual frequency bins, e.g., in the frequency domain. The amount of signal energy to be placed in each frequency bin is based in part upon other sound in the environment, such that the test signal may be indistinguishable (by the human ear) from the other sounds in the environment. Other sounds in the environment may be determined from playback signals processed by an audio system (which may be the same audio system as the systems and methods herein), or from various microphone(s) in the environment (which may also be microphone(s) used for the systems and methods herein), or a combination of playback signals and microphone signals, each of which may indicate other sounds in the environment.

The test signal is provided to one or more acoustic transducers (e.g., loudspeakers) and transduced into acoustic signals in the environment. The acoustic signals propagate to one or more microphones that produce microphone signals representative of the acoustic signals received by them.

A processor receives the one or more microphone signals and may also receive the test signal from the generator and processes these signals to estimate the acoustic transfer function(s) from each of the one or more acoustic transducers to each of the one or more microphones. For simplicity, only a single transfer function (from one transducer to one microphone) is described further below.

Systems and methods herein may generate and process audio test signals (or training signals) for an extended duration. In various examples, a duration of test signal processing may be 3 seconds or longer, 5 seconds or longer, 10 seconds or longer, 20 seconds or longer, or 60 seconds or longer. Such an extended duration may allow for significant processing gain and may be beneficial at least in part because the test signal is of a low signal level (low energy) relative to other sounds in the environment. Accordingly, a short duration signal may be difficult to detect and/or to estimate the characteristics of the acoustic channel because there may be much more acoustic energy in the environment that is not associated with the test signal. However, an extended duration allows for processing gains because the (known) test signal is present in the environment while the other sounds may be variable and constantly changing. In at least one example, a received microphone signal may be continuously averaged (e.g., storing a portion, such as a window length of the signal, and adding the next portion, and so on, and dividing by the total number of portions) such that the other sounds may average out to zero, or a null effect (e.g., the other sounds may be considered random with respect to the extended duration test/training signal and thus subtract from the average as much as they add to the average, yielding a net zero or null effect). Accordingly, such processing by systems and methods herein may be deemed a summing process or a summing method which is applied to the one or more microphone signals.

A continuous summation and dividing by the number of portions of a signal may require significant memory and processing power. Accordingly, various examples of systems and methods herein may employ various techniques of a summing method intended to reduce the required memory and processing (e.g., processor calculations). For example, the summing method may receive one portion of the microphone signal and add a fractional value of the received portion to a previously stored accumulation of portions, then store the result as a new stored accumulation of portions. For instance, if a certain summing method is intended to produce a result that is representative of one hundred (100) samples (e.g., one hundred portions or time domain windows of a microphone signal), the summing method may receive the next portion of the microphone signal and add 1/100-th of the received portion to 99/100-th's of a previously stored accumulation of portions and store the result as a new stored accumulation. Such a scheme produces a running average essentially representative of the average of the past one hundred (100) portions. Such a scheme, or similar schemes, may require only a single representative (accumulated) portion to be stored in memory, and may not require a counter of the number of previous portions, and may only require relatively simple mathematical operations to be processed. Mathematically, the resulting output, y(k), may be expressed as:

y(k)=αy(k−1)+βx(k) (1)

wherein y(k−1) is the previously stored accumulation of portions, x(k) is the current portion of the microphone signal, and y(k) is the resulting output and the newly stored accumulation. α and β are fractional values that, in some examples, may add up to one (unity). Accordingly, in various examples α+β=1 but other examples may include fractional values that do not add up to unity or may include varying summing methods.

By accumulating (summing) received microphone signal(s) over a duration of time, a processor or processing method may determine an estimated transfer function (channel characteristic) relative to the known test signal that caused the resulting received signal(s). Essentially, a ratio of the resulting output (accumulated representative portion of the received signal at the microphone) to the test/training signal input yields the transfer function (also known as the impulse response) of the acoustic environment from the acoustic transducer to the microphone.

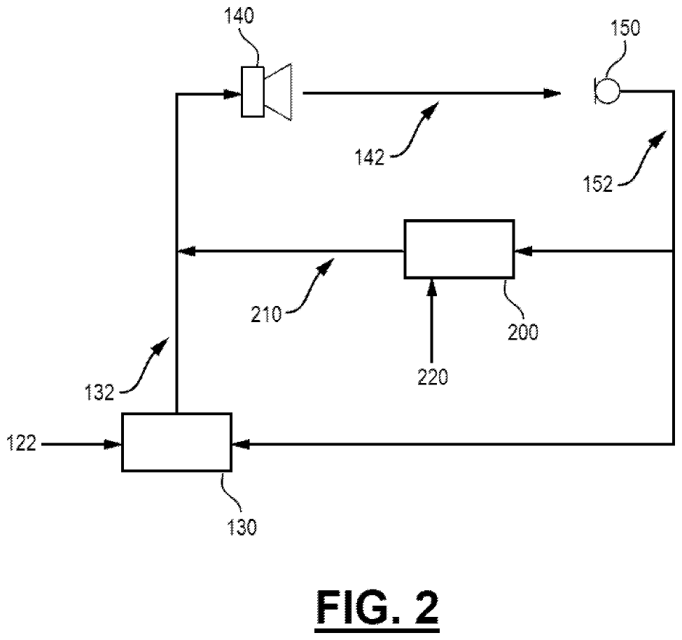

FIG. 2 illustrates an example testing system 200 that acts to determine an estimated transfer function of, e.g., secondary path 142. System 200 generates an audio test signal 210 having amplitudes and/or energies in various frequency bins that are selected based upon other acoustic energy in the environment. The selection of amplitude and/or energy for any given frequency bin may be selected such that the audio test signal 210 may be effectively masked in the environment, which is to say that the audio test signal 210, when transduced into an acoustic signal by an acoustic transducer—such as by acoustic transducer 140 in this example—it may not be distinguishable from the other acoustic energy in the environment, i.e., occupants in the environment may be unlikely to detect that the audio test signal 210 has been transduced into the environment. In various examples, the system 200 may determine the other acoustic energy in the environment by receiving a microphone signal from the environment—such as from microphone 150—or from other inputs 220, which may include from an audio system having access to other signals being played through in the environment, e.g., music, radio, etc. In some examples, the other acoustic energy in the environment may include fan or wind noise that may be particularly beneficial for masking the transduced audio test signal.

In various examples, the testing system 200 may include various processors, such as one or more general purpose processors and/or digital signal processors, coupled to memory that may store instructions that cause the processor(s) to behave as described above and further below, and may include various input and output interfaces to, e.g., receive one or more microphone signals and provide one or more audio test signals as described herein.

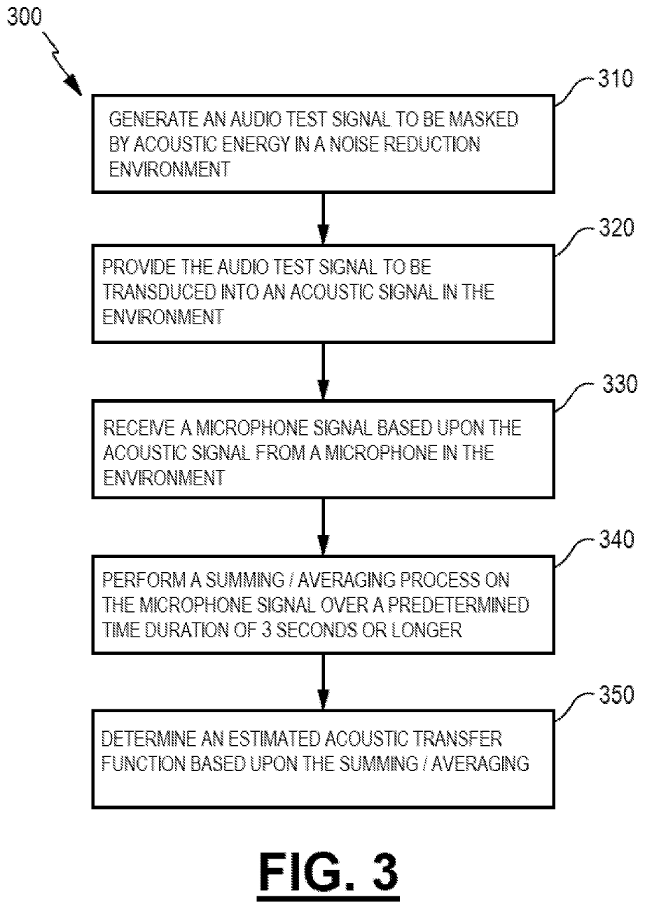

FIG. 3 illustrates an example acoustic path testing method 300. The method 300 generates 310 an audio test signal to be masked in the environment. The amplitude or energy of the audio test signal is selected, across a plurality of frequency bins, at least in part, to be at least partially masked by acoustic energy in the environment. The audio test signal is provided 320 to a transducer to be transduced into an acoustic signal in the environment. A microphone signal is received 330 from a microphone based upon the acoustic signal at the microphone in the environment. A summing (or averaging) method is performed 340 on the microphone signal over a predetermined time duration of three (3) seconds or longer, and an estimated acoustic transfer function is determined 350 based upon the summing or averaging method.

Examples of the methods and apparatuses discussed herein are not limited in application to the details of construction and the arrangement of components set forth in the above descriptions or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Also, the phraseology and terminology used herein is for the purpose of description and should not be regarded as limiting. Any references to examples, components, elements, acts, or functions of the systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation, unless the context reasonably implies otherwise.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A method of estimating an acoustic transfer function in an environment between a transducer and a microphone, the method comprising:
generating an audio test signal, wherein an amplitude or energy of the audio test signal is selected, across a plurality of frequency bins, at least in part, to be at least partially masked by acoustic energy in the environment;
providing the audio test signal to the transducer to be transduced into an acoustic signal in the environment;
receiving a microphone signal from the microphone based upon the acoustic signal at the microphone in the environment;
performing a summing method on the microphone signal over a predetermined time duration of three (3) seconds or longer; and
determining the estimated acoustic transfer function based upon the summing method.

2. The method of claim 1 wherein the predetermined duration is at least one of five (5) seconds or longer, ten (10) seconds or longer, twenty (20) seconds or longer, or sixty (60) seconds or longer.

3. The method of claim 1 wherein the amplitude or energy of the audio test signal is selected based at least in part upon an acoustic energy content in the environment.

4. The method of claim 1 wherein the amplitude or energy of the audio test signal is selected based at least in part upon an energy content of a playback signal, the playback signal also being transduced into the environment.

5. The method of claim 1 wherein the summing method comprises:
adding a first fractional value of the microphone signal to a second fractional value of a stored signal; and
saving the result as a new version of the stored signal.

6. The method of claim 5 wherein the first fractional value and the second fractional value add up to unity.

7. The method of claim 5 wherein the summing method further comprises repeatedly adding subsequent first fractional values of the microphone signal to subsequent second fractional values of the stored signal and saving the result as a next subsequent version of the stored signal multiple times over the duration.

8. The method of claim 7 wherein the repeated summing method is performed at least one of ten (10) times or more, twenty (20) times or more, one hundred (100) times or more, or two hundred (200) times or more over the duration.

9. The method of claim 1 wherein the summing method is performed on each of a plurality of frequency bins of the microphone signal.

10. An audio system comprising:
a transducer;
a microphone; and
a processor coupled to the transducer and the microphone and configured to:
generate an audio test signal, wherein an amplitude or energy of the audio test signal is selected, across a plurality of frequency bins, at least in part, to be at least partially masked by acoustic energy in an environment,
provide the audio test signal to the transducer to be transduced into an acoustic signal in the environment,
receive a microphone signal from the microphone based upon the acoustic signal at the microphone in the environment,
perform a summing method on the microphone signal over a predetermined time duration of three (3) seconds or longer, and
determine an estimated acoustic transfer function based upon the summing method.

11. The audio system of claim 10 wherein the predetermined duration is at least one of five (5) seconds or longer, ten (10) seconds or longer, twenty (20) seconds or longer, or sixty (60) seconds or longer.

12. The audio system of claim 10 wherein the amplitude or energy of the audio test signal is selected based at least in part upon an energy content of a playback signal, the playback signal also being transduced into the environment.

13. The audio system of claim 10 wherein the summing method comprises:
repeatedly adding a fractional value of the microphone signal to a fractional value of a stored signal and saving each result as a new version of the stored signal.

14. The audio system of claim 13 wherein the repeated adding and storing is performed at least one of ten (10) times or more, twenty (20) times or more, one hundred (100) times or more, or two hundred (200) times or more over the duration.

15. The audio system of claim 14 wherein the summing method is performed on each of a plurality of frequency bins of the microphone signal.

16. A non-transitory computer readable medium having instructions stored thereon that, when executed by a suitable processor coupled to a transducer and a microphone, causes the processor to perform a method comprising:
generating an audio test signal, wherein an amplitude or energy of the audio test signal is selected, across a plurality of frequency bins, at least in part, to be at least partially masked by acoustic energy in an environment;
providing the audio test signal to the transducer to be transduced into an acoustic signal in the environment;
receiving a microphone signal from the microphone based upon the acoustic signal at the microphone in the environment;
performing a summing method on the microphone signal over a predetermined time duration of three (3) seconds or longer; and
determining an estimated acoustic transfer function based upon the summing method.

17. The computer readable medium of claim 16 wherein the predetermined duration is at least one of five (5) seconds or longer, ten (10) seconds or longer, twenty (20) seconds or longer, or sixty (60) seconds or longer.

18. The computer readable medium of claim 16 wherein the amplitude or energy of the audio test signal is selected based at least in part upon an energy content of a playback signal, the playback signal also being transduced into the environment.

19. The computer readable medium of claim 16 wherein the summing method comprises repeatedly adding a fractional value of the microphone signal to a fractional value of a stored signal and saving each result as a new version of the stored signal.

20. The computer readable medium of claim 19 wherein the repeated adding and storing is performed at least one of ten (10) times or more, twenty (20) times or more, one hundred (100) times or more, or two hundred (200) times or more over the duration.
